(19) United States
(12) Patent Application Publication
(10) Pub. No.: US 2009/0272734 A1
(43) Pub. Date: Nov. 5, 2009

(54) Induction Heater

(75) Inventors: Christoph Fuelbier, Lohmar (DE); Ingolf Hahn, Bonn (DE); Carsten Buehrer, Bonn (DE); Thomas Braun, Ettringen (DE)

Correspondence Address: EDELL, SHAPIRO & FINNAN, LLC, 1901 RESEARCH BOULEVARD, SUITE 400, ROCKVILLE, MD, 20850, US

(73) Assignee: ZENERGY POWER GMBH, Rheinbach (DE)

(21) Appl. No.: 12/504,023

(22) Filed: Jul. 16, 2009

Related U.S. Application Data
(63) Continuation of application No. PCT/EP2008/005646, filed on Jul. 10, 2008.

(30) Foreign Application Priority Data
Jul. 26, 2007 (DE) 202007014930.1
Oct. 25, 2007 (DE) 102007051144.4

(51) Int. Cl. H05B 6/10

(52) U.S. Cl. 219/637

(57) ABSTRACT

An induction heater for heating metallic billets with a yoke of E-shaped cross-section, on the middle limb of which a superconducting coil is seated, has a well located between the middle limb and each one of the respective two outer limbs. A billet can be heated by being rotated in each one of the two wells.

### CROSS REFERENCE TO RELATED APPLICATIONS

This application is a continuation of International Application No. PCT/EP2008/005646, filed on Jul. 10, 2008, entitled “Induction Heater,” which claims priority under 35 U.S.C. §119 to Application No. DE 202007014930.1 filed on Jul. 26, 2007, entitled “Induction Heater,” and to Application No. DE 102007051144.4 filed on Oct. 25, 2007, entitled “Induction Heater,” the entire contents of each of which are hereby incorporated by reference.

### FIELD OF THE INVENTION

The invention relates to an induction heater with a direct-current fed superconducting coil arrangement on a yoke.

### BACKGROUND OF THE INVENTION

In an induction heater for heating a billet of an electrically conducting material, a billet is rotated in a well between two limbs of a yoke having a C-shaped cross-section. A direct-current fed high-temperature superconducting coil is seated on the yoke. Designated as being high-temperature superconducting (HTSC) are cuprate superconductors, e.g. YBCO and, more generally, all superconductors (SC) having an SC transition temperature above the boiling point of liquid nitrogen. As a rule, induction heaters are incorporated in a production line. Therefore the induction heater must provide a heated billet according to timing set by the production line.

One type of conventional induction heater having a generally E-shaped yoke includes three limbs, each of which are designed as pole pieces. The limbs are disposed in a star-shaped configuration at angular displacements of 120 degrees from each other in order to heat by induction a work-piece in the space between the pole pieces with alternating-current fed coil arrangements seated on the pole pieces.

Another type of induction heater includes an E shaped yoke with a first coil arrangement seated on the middle limb of the yoke, and the end limbs directed towards each other. The work-piece to be heated is located between the spaced end faces of the end limbs of the yoke, and is surrounded by another coil arrangement which is alternating-current fed and primarily supplies the power for inductive heating of the work-piece.

Still another type of induction heater includes an E-shaped yoke having three limbs that each support an alternating-current fed coil arrangement in order to heat by induction the work-piece located in the free space between the limbs.

It would be desirable to provide an induction heater having an increased billet output per unit of time, and low energy consumption.

### SUMMARY OF THE INVENTION

An induction heater for heating metallic billets with a yoke of E-shaped cross-section, on the middle limb of which a superconducting coil is seated, has a well located between the middle limb and each one of the respective two outer limbs. A billet can be heated by being rotated in each one of the two wells.

### BRIEF DESCRIPTION OF THE DRAWINGS

FIG. 1 illustrates a partial cross-sectional side view of an induction heater in accordance with an embodiment of the invention.

FIG. 2 illustrates a cross-sectional view of the magnet unit of the induction heater of FIG. 1 in accordance with an embodiment of the invention.

FIG. 3 illustrates a side view of the magnet unit of the induction heater of FIG. 1.

FIG. 4 illustrates a cross sectional view taken along lines B/B of FIG. 3.

FIG. 5 illustrates magnet unit of an induction heater in accordance with another embodiment of the invention.

FIG. 6 illustrates a bottom schematic view of a magnet unit in accordance with an embodiment of the invention.

FIG. 7 illustrates a cross-sectional view of a magnet unit in accordance with an embodiment of the invention.

FIG. 8 illustrates a cross-sectional view of a magnet unit in accordance with an embodiment of the invention.

FIG. 9 illustrates a cross-sectional view of a magnet unit in accordance with an embodiment of the invention.

FIG. 10 illustrates a cross-sectional view of a magnet unit in accordance with an embodiment of the invention

Like reference numerals in the various figures are utilized to designate like components.

### DETAILED DESCRIPTION OF THE INVENTION

The induction heater in accordance with the present invention includes a yoke of at least approximately E-shaped cross-section, consisting of a middle limb between two outer limbs, with the middle limb and the two outer limbs being connected by a cross limb. At least one superconducting coil is seated on one of the mentioned limbs. Between each of the two outer limbs and the middle limb is a well in which a billet can be heated by being rotated within the well. Because the induction heater has two wells, two billets can be heated at the same time. For example, while a heated billet is being exchanged for a new cold billet, another billet can be heated in the other well. The yield from the induction heater is increased accordingly. The E-shape of the yoke makes it possible to increase significantly the yield of heated billets with only one superconducting coil. Usually, the coil is a part of a coil arrangement which, as a rule, comprises at least also the connecting terminals for the coil.

For example, the coil or the coil arrangement may be seated on the middle limb. Alternatively, two coils or coil arrangements may be seated on the cross-limb, with preferably one coil or coil arrangement on each side of the middle limb. Naturally, one coil can be seated also on each of the outer limbs.

The further developments of the invention described are not restricted to the E-shape of the yoke, and not to the number of wells, in particular.

The two outer limbs and the middle limb of the yoke are connected by a cross-limb. Preferably the coil arrangement, or the coil, is slide-fitted onto the middle limb until it abuts against the cross-limb. This makes possible a compact yoke with correspondingly shorter magnetic return-flux path, whereby the efficiency of the induction heater is improved.

Preferably, the limbs of the yoke consist of solid material. Because the coil is fed by direct current, an expensive structure of a yoke consisting of laminated sheets can be dispensed with, without eddy current losses in the yoke, caused by eddy currents, having to be tolerated. Owing to the absence of laminations which would also provide an electric insulation, the magnetic bulk factor is increased over that of a variant including metal sheets. This permits of either an increase of the magnetic field, or a more cost-advantageous structure using simpler materials for the same magnetic field strength.

The coil arrangement preferably comprises an evacuated chamber in which at least one HTSC coil is located. The evacuated chamber makes possible a good heat insulation of the HTSC coil.

The heat insulation is further improved when the HTSC coil is sheathed with a plurality of layers of a metal-coated foil, preferably an aluminum-vapor-coated foil.

The HTSC coil can be supported in the chamber by means of synthetic material bearings.

A heat insulator between the coil arrangement and the open ends of the wells reduces the cooling power needed for the HTSC coil. Particularly suitable are micro-porous heat insulators. A suitable material for the heat insulator is calcium silicate, in particular.

In addition or as an alternative to the heat insulator, an infrared reflector which reflects in the direction towards the billets and is made, for example, of a gold-vapor-coated ceramic can be located in the wells. Heat losses are thereby reduced. Particularly suitable is an infrared reflector of U-shaped cross-section, in the free middle portion of which the billet is rotated.

Preferably an impact protection plate having a high magnetic resistance compared with that of the yoke, e.g. of stainless or special steel (V2A, V4A etc.), is located in front of the coil arrangement in each well. Should a rotating billet become disengaged from its support, then the impact protection plate prevents the more costly and sensitive superconducting coil arrangement from becoming damaged. Each of the impact protection plates can be seated, for example, in two opposite longitudinal grooves in the associated well.

Preferably, the wells are tapered along the direction towards the free ends of the limbs, i.e. the limbs are thickened correspondingly. Thereby the air-gap between the free ends of the limbs, in which the billets are rotated, is shortened. Correspondingly, the magnetic resistance is reduced, and the maximum heating power and efficiency are increased.

The wells may be closed to the environment by a heat insulator. For the billets to be removed from or inserted into the wells, the heat insulator closing the wells is preferably movable.

In addition, the wells may be closed to the environment by non-magnetic, protective plates. These protective plates prevent a rotating billet which has become disengaged from its clamping device from leaving the well and damaging other machine components, or even injuring persons. Of course, also the protective plates are preferably movable for the wells to be opened.

The width of the wells may be selectively adjusted. As a result, the wells can be adapted to different billet diameters. This may be achieved, for example, by sliding or swiveling at least one lower portion of the outer limbs. The lower portion of the outer limbs also can be segmented in a plane orthogonal to the rotation axis. For effecting an adjustment to the field in a respective well, the segments may be slid or swiveled independently from each other. Alternatively, the widths of the wells may be adjusted with ferromagnetic metal plates interchangeably attached to the limbs of the yoke.

Metal plates of this kind can have a higher relative magnetic permeability than the yoke. This leads to a concentration of the magnetic flux through the metal plates, and therewith also through the billet being rotated between the metal plates. When especially large billets are to be heated, the metal plates also can have a lower relative permeability than the yoke; consequently, the metal plates act in a scattering manner, and correspondingly the magnetic flux acts more uniformly.

The widths of the wells can increase from the end faces of the yoke towards the middle. For this, ferromagnetic metal wedges can be interchangeably attached to the limbs of the yoke. This geometry of the wells reduces the stray fields issuing from the wells at the end faces of the yoke, and the magnetic field through the billets is increased correspondingly.

For adjustment of the width of the wells, be it by shifting or swiveling parts of the outer limbs or by exchanging interchangeably attached metal plates or wedges, the HTSC coil is preferably first switched off. Subsequently, the width of the wells can be then changed easily. The width of the wells can be changed particularly easily when, after the coil has been switched-off and before the width is changed, the yoke is demagnetized. For this, for example, a coil arrangement seated on the yoke, in particular the superconducting coil arrangement, can be fed with alternating current. The current strength for feeding with alternating current is lower than the rated current strength for feeding with direct current. Preferably it amounts to about 10 to 20% of the rated current for feeding with direct current.

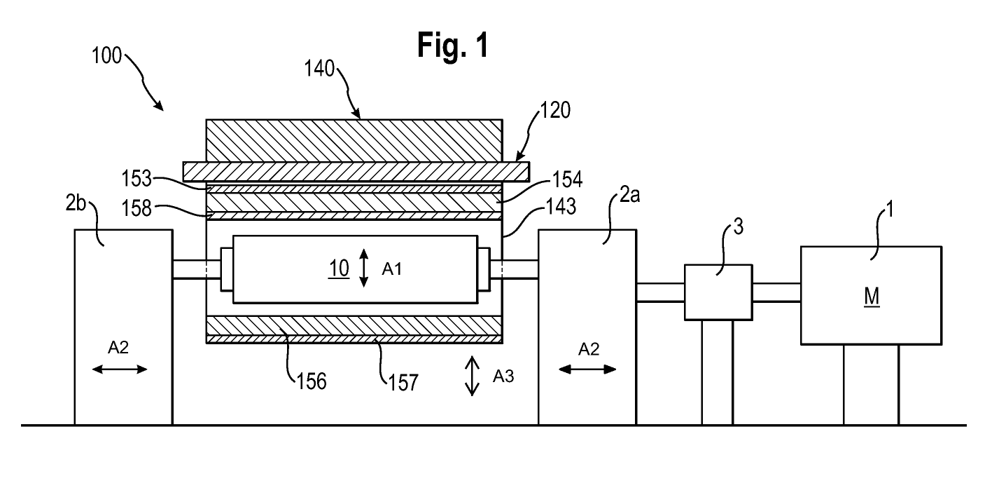

Referring to FIG. 1, the induction heater has a two-part clamping device 2a, 2b which holds a billet 10 in a well of a magnet unit 100. The billet 10 is driven to rotate via a part of the clamping device 2a, a gear unit 3, and a motor 1. The billet 10 can be raised and lowered, as indicated by arrows A1, via the clamping device 2a, 2b. In addition, the clamping devices 2a, 2b may be also adapted to for lateral displacement (i.e., may be configured to travel horizontally, indicated by arrows A2.

The billet 10 is located in a well of a yoke 140 having a substantially E-shaped cross-section, on the middle limb of which yoke a coil arrangement 120 is seated. The yoke 140 may be formed from solid material. The yoke possesses a generally E-shaped cross-section defined by a first or left outer limb 142l, a second or right outer limb 142r, and a middle limb 143. The limbs 142l, 142r, 143 are connected via a cross-limb 141. A first or left well 150l having an open lower end is defined by the left outer limb 142l and the middle limb 143. Similarly, a second or right well 150r having an open lower end is defined by the right outer limb 142r and the middle limb 143.

The coil arrangement 120 includes an evacuated chamber 125 in which a high-temperature super conducting (HTSC) coil 121 is located. The HTSC coil 121 may be cooled e.g., with liquid nitrogen (cooling means and electrical leads are not illustrated). The HTSC coil 121 is located in a housing 122 and is fixed in the chamber 125 by a synthetic material holder (not illustrated). The HTSC coil 121 is sheathed by a plurality of layers of an A1-vapor-coated polyester foil as a heat insulator 123. A good heat-insulation is achieved with about 40 to 60 layers of the foil, with about preferably 10 to 20 further layers located at the edges.

An impact protection plate 153 is located below the chamber 125 in each well 150l, 150r. The impact protection plates 153 are formed from a non-magnetic material, e.g., stainless or special steel, and are seated in opposite longitudinal grooves in their respective wells 150l, 150r. For assembly, the impact protection plates 153 are inserted from one of the end faces of the yoke to slide along the longitudinal grooves 152, and then fastened. The impact protection plates 153 protect the coil arrangement 120 from being damaged by a rotating billet 10 which has become released from the clamping device 2a, 2b.

Below the impact protection plate 152 is a first or upper heat insulator 154. The heat insulator 154 may be formed by one or more calcium silicate plates that directly adjoin the impact protection plate 153. The first heat insulator 154 protects the coil arrangement 120 and the yoke 140 from the heat of the billets 10 in the same way as the adjoining infrared reflector 158 of U-shaped cross-section and gold-vapor-coated ceramic. Furthermore, the losses by heat emission from the billet to the yoke are lessened.

The wells 150l, 150r are tapered at their lower ends by means of ferromagnetic plates 155 which are interchangeably fastened to the outer limbs 142l, 142r, or to the middle limb 143. As a result, the air gap between the limbs 142l, 142r and 143 of the yoke 140 and the billets 10 is shortened, and the magnetic resistance of the magnet unit 100 is correspondingly reduced. The plates 155 have a higher magnetic permeability than the yoke 140. Therefore, the plates 155 concentrate the magnetic flux through the billets 10. By comparison with an embodiment in which the wells have a constant reduced width corresponding to the distance between the plates 155, the embodiment shown here has the advantage that the wells 150l, 150r are effectively widened along an upward direction, whereby the evacuated chamber 125 is made correspondingly larger and the insulation of the HTSC coil 121 is improved. The interchangeable attachment of the plates 155 makes possible a simple assembly of the magnet unit 100, and also an adaptation of the width of the wells 150l, 150r to the diameter of the billets 10 to be heated.

The lower ends of the wells 150l, 150r may be closed by a second or lower heat insulator 156. The heat insulator 156 lies in a channel of three protective plates 157. The protective plates 157 are of a non-magnetic material, for example stainless or special steel, and serve to prevent accidents. Should a billet 10 unexpectedly become disengaged from the clamping device 2a, 2b during the heating, then it cannot leave the corresponding well 150l, 150r, which means that it can neither damage other system components, nor injure persons. The heat insulator 156 and the protective plates 157 are adapted to be raised and lowered, as indicated by double arrows A3. Thereby the wells 150l, 150r can be opened in order to insert a billet 10 from below into the corresponding well.

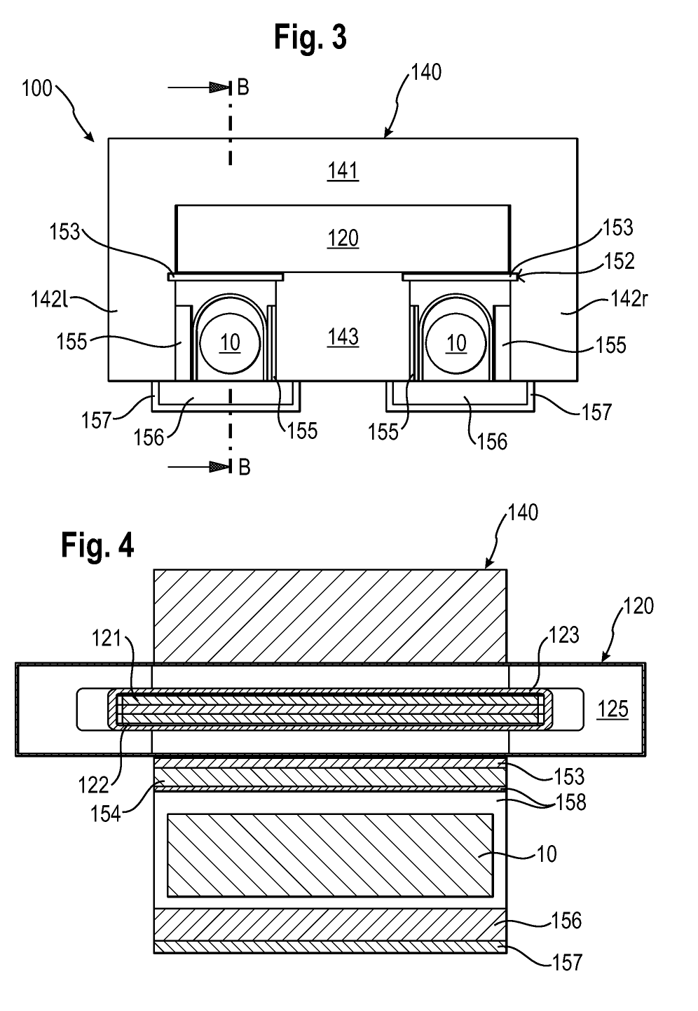

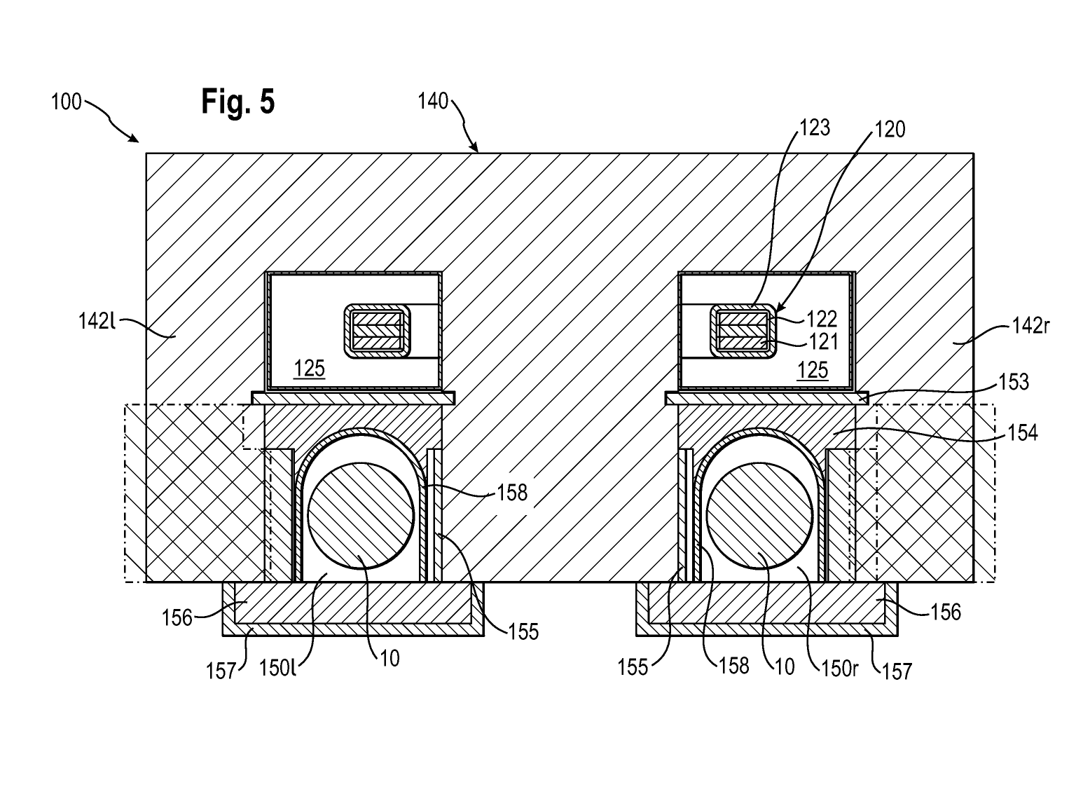

The embodiment in FIG. 5 corresponds substantially to the embodiment in FIGS. 1 to 4, however, the lower component parts of the two outer limbs 142l and 142r are adapted to be displaced in order to conform the width of the wells 150l, 150r to billets 10 having different diameters (indicated by dashed lines). The displaceable part of the two outer limbs 142l, 142r is shown in two positions, with the open position being indicated by a hatching which is counter-directed to the hatching usually employed for the yoke 140.

For adapting the heat insulator 154 and the infrared reflectors 158 to a changed well width, they can be either completely exchanged or adapted to be of telescopically adjustable width (not illustrated).

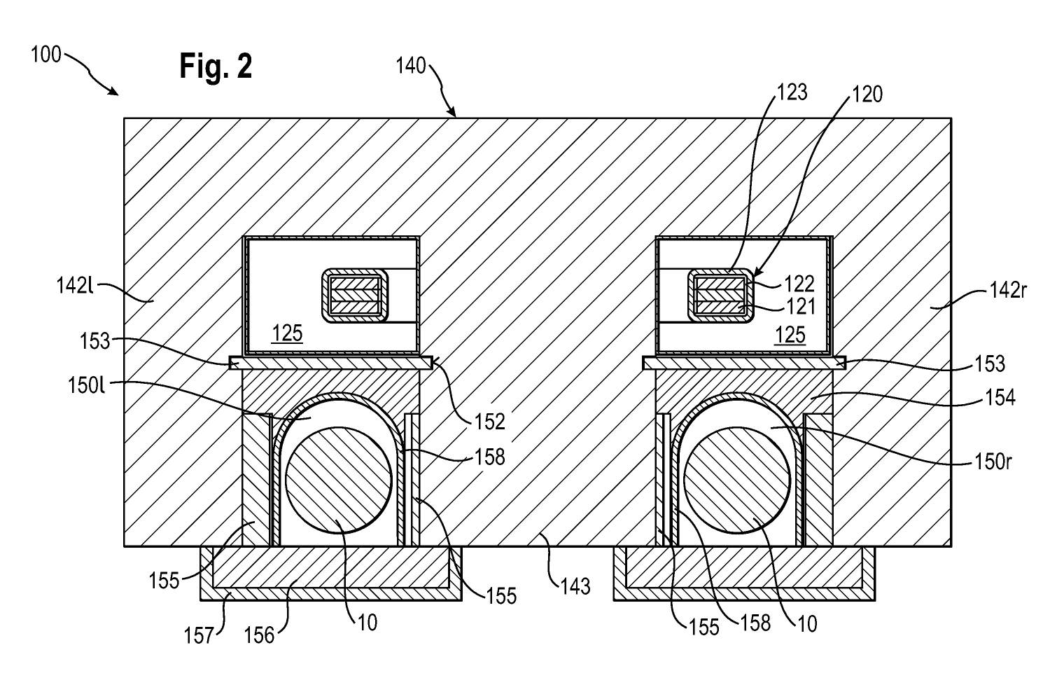

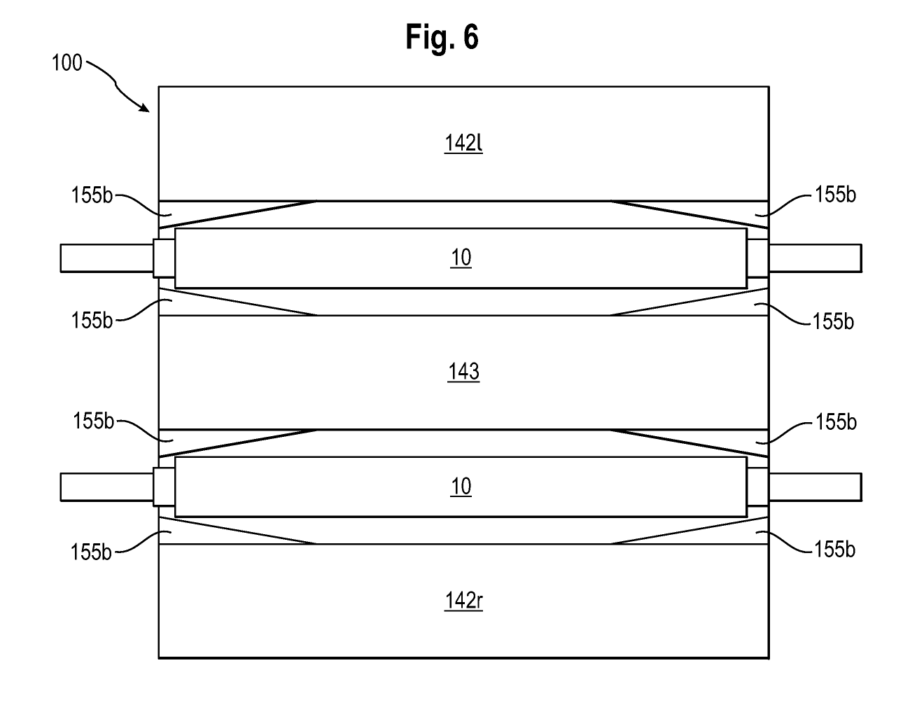

The magnet unit 100 shown in FIG. 6 is substantially similar to that of the other induction heaters of the other Figures. Instead of the plates 153 in FIG. 2 and FIG. 5, metal wedges 155b are attached to the outer limbs 142l and 142r and on both sides of the middle limb 143 so as to be exchangeable and displaceable relative to each other. Thereby the width of the wells 150l and 150r increases from the end faces towards the middle. This reduces stray fields that emerge from the end faces and makes it possible to adapt the field to form a field profile. By displacing the metal wedges 155b parallel to the rotation axis it is possible thus to adapt to, for example, different materials or geometries. The efficiency of the magnet unit 100 is correspondingly improved.

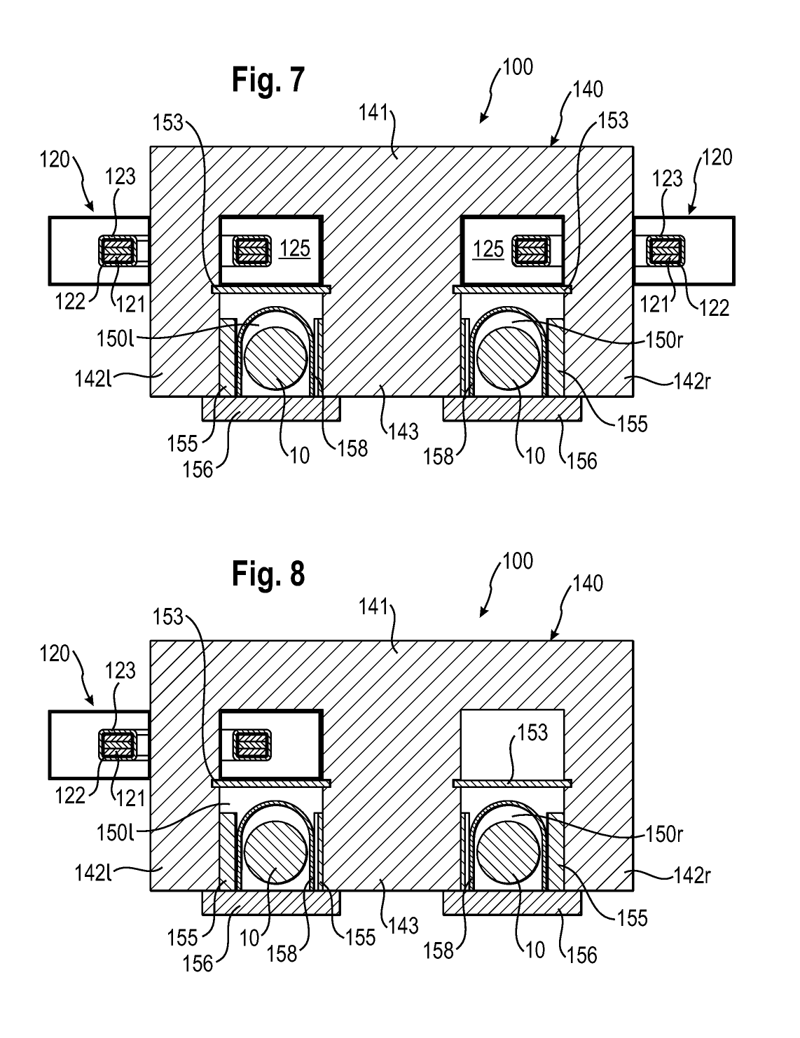

The magnet units 100 shown in the FIGS. 7 to 10 are generally similar to the induction heaters 100 in FIGS. 1 to 4. For example, the magnet unit 100 of FIG. 7 has a coil arrangement 120 on the right-hand side outer limb 142r and a coil arrangement 120 on the left-hand side outer limb 142l, instead of a coil arrangement on the middle limb 143 as in FIGS. 1 to 4. The induction heater 100 in FIG. 8 has merely one coil arrangement which is seated on the left-hand side outer limb 142l and has been slide fitted onto this until it abuts against the cross-limb 141.

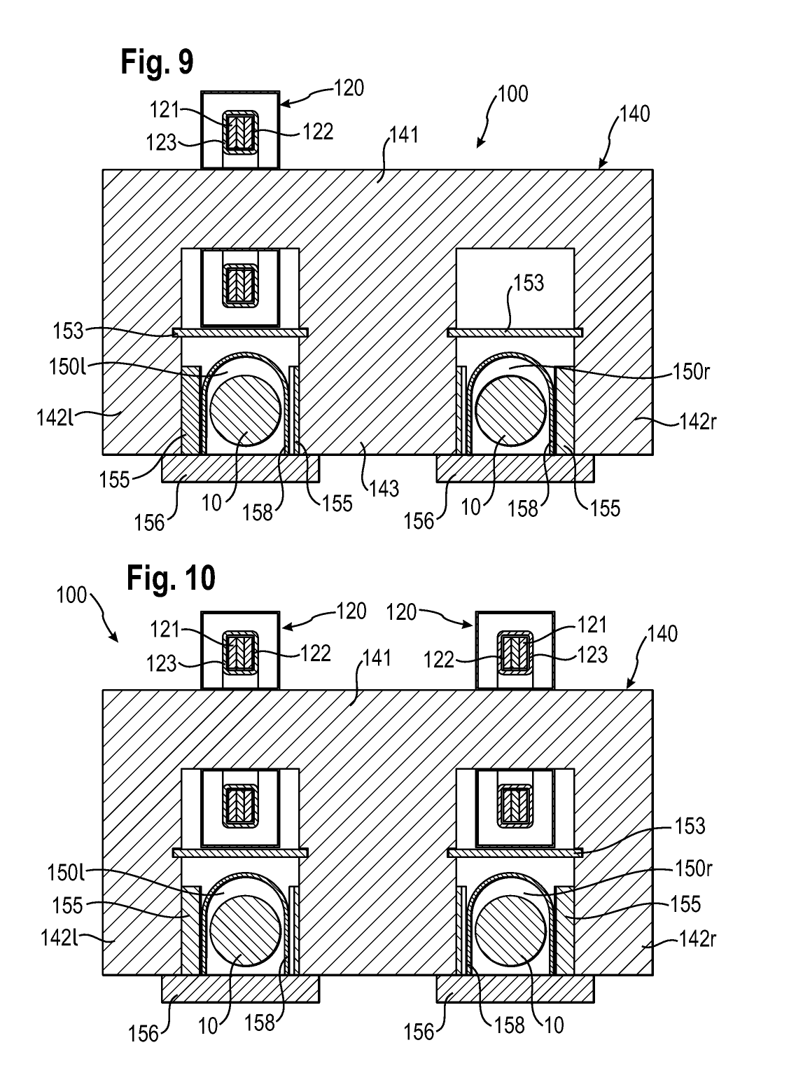

FIG. 9 shows an magnet unit 100 with a coil arrangement 120 that is seated on the cross-limb 141 between the left-hand side outer limb 142l and the middle limb 143. To enable mounting of a pre-assembled coil arrangement 120, the left-hand side outer limb 142l differs from that illustrated by being adapted to be demounted.

FIG. 10 shows a magnet unit 100 with one coil arrangement 120 seated on the cross-limb 141 on each of the two sides of the middle limb 143. To enable mounting of a pre-assembled coil arrangement 120, the two outer limbs 142l, 142r differ from those illustrated by being adapted to be demounted.

What is claimed is:

1. Induction heater comprising at least one direct-current fed superconducting coil disposed on a yoke for heating billets, the induction heater including:
a first outer limb, a second outer limb, and a middle limb located between two outer limbs, the outer an middle limbs being disposed on a common cross-limb;
a first well configured to accommodate one billet to be heated, the first well being located between the first outer limb and the middle limb; and
a second well configured to accommodate one billet to be heated, the well being located between the second outer limb and the middle limb.

2. The induction heater according to claim 1, wherein the superconducting coil is slide-fitted onto the middle limb of the yoke until it abuts against the cross-limb.

3. The induction heater according to claim 1, wherein at least one limb of the yoke is made of solid material.

4. The induction heater according to claim 1, wherein the coil is a high-temperature superconducting coil disposed in an evacuated chamber of a coil arrangement.

5. The induction heater according to claim 4, wherein synthetic material bearings support the coil in the chamber.

6. The induction heater according to claim 1, wherein the coil is sheathed with a plurality of layers formed of a metal-vapor-coated foil.

7. The induction heater according to claim 1, wherein:
the first well and the second well each includes an open end; and
the induction heater further comprises a heat insulator oriented between the coil and the open ends of the wells.

8. The induction heater according to claim 7, wherein the heat insulator is micro-porous.

9. The induction heater according to claim 7, wherein the heat insulator is formed of calcium silicate.

10. The induction heater according to claim 1 further comprising:
a first non-magnetic impact protection plate associated with the first well; and
a second non-magnetic impact protection plate associated with the second well.

11. The induction heater according to claim 10, wherein each well comprises two oppositely-located longitudinal grooves in which one of the impact protection plates are seated.

12. The induction heater according to claim 1, wherein the wells taper towards free ends of the limbs.

13. The induction heater according to claim 1, wherein:
the wells are each covered by a heat insulator; and
each heat insulator is movable to selectively expose the wells.

14. The induction heater according to claim 1, wherein:
each well is covered by a non-magnetic impact protection plates; and
each protection plate is moveable to enable opening of the wells.

15. The induction heater according to claim 1, wherein the width of each well is selectively adjustable such that the width may be selectively increased or decreased.

16. The induction heater according to claim 15, wherein the width of each well is adjusted by shifting or swiveling a portion of its associated outer limb.

17. The induction heater according to claim 15, wherein the width of each well is adjusted via a ferromagnetic metal plate that is fastened to the limbs of the yoke.

18. The induction heater according to claim 17, wherein the relative magnetic permeability of the metal plates is different from that of the yoke.
